(19) United States
(12) Patent Application Publication
(10) Pub. No.: US 2010/0074502 A1
(43) Pub. Date: Mar. 25, 2010

(54) Retrospective reconstruction of magnetic resonance images

(76) Inventor: Marcus Wübbe, Erlangen (DE)

Correspondence Address: HARNESS, DICKEY & PIERCE, P.L.C., P.O.BOX 8910, RESTON, VA, 20195, US

(21) Appl. No.: 12/585,538

(22) Filed: Sep. 17, 2009

(30) Foreign Application Priority Data
Sep. 22, 2008 (DE) 10 2008 048 305.2

(51) Int. Cl. G06K 9/00

(52) U.S. Cl. 382/131

(57) ABSTRACT

A method, a system, a computer program product and a memory module are disclosed for computing images on the basis of raw data from an MR unit. In at least one embodiment, the raw data captured by the MR unit are buffered in a memory. When the raw data have been read from the buffer store, the parameters are captured by a computation unit, which computes an image from the raw data. In at least one embodiment, one and the same set of raw data can be used a plurality of times for differently parameterized computations by the computation unit without the need for fresh capture of the raw data.

### PRIORITY STATEMENT

The present application hereby claims priority under 35 U.S.C. §119 on German patent application number DE 10 2008 048 305.2 filed Sep. 22, 2008, the entire contents of which are hereby incorporated herein by reference.

### FIELD

At least one embodiment of the invention generally relates to the fields of medical engineering and information technology and at least one embodiment relates, more particularly, to the computation of medical images on the basis of raw data, the raw data having been captured by imaging medical appliances.

### BACKGROUND

In imaging medical engineering, provision is fundamentally made for raw data which have been acquired by way of an imaging method to be supplied to a computer which is designed to take the raw data and produce medical images that can be used by a user and which may also be able to execute further processing steps—for example within the context of post-processing. The images are computed on the basis of the raw data captured by the magnetic resonance tomograph (subsequently also called MR unit or MRI modality for short). However, computation of the images requires not only the raw data but also further parameters to be determined, so that the computation to form an image can actually be performed.

In medical practice, however, it is frequently necessary and usual to apply different parameters to one and the same data set of raw data, which results in different images being generated.

In the known systems from the prior art, it is disadvantageously necessary to have to take a new measurement with a patient if the intention is for the images to be computed using changed measurement parameters. It is obvious that a repeat medical examination of a patient is both disadvantageous for the patient (increased radiation exposure and unnecessary repeat examination) and holds drawbacks for a computer-based clinical system (unnecessary occupancy of the magnetic resonance tomograph or of the respective medical modality, tying-up of resources in terms of computation power and transmission capacity).

### SUMMARY

In at least one embodiment of the present invention a way of improving, particularly of simplifying and rendering more flexible, the computation of medical images is demonstrated on the basis of raw data which have been acquired using an imaging method.

The text below describes the solution to the problem according to at least one embodiment of the invention with reference to the method. Features, advantages and/or alternative embodiments mentioned in this regard are likewise also transferred to the other categories of claim (that is to say to the system, to the computer program product and to the memory module), and vice versa. Corresponding functional features of the method are then in the form of appropriate object-type modules, particularly hardware modules, for an object-type solution. Since, on the basis of the principles of information technology and particularly on the basis of Church's thesis, a software-based solution is basically equivalent to a hardware-based solution, it is irrelevant whether the solution to the respective problem is implemented in software or in appropriate hardware modules. By way of example, the method step of “computing images” can thus be transferred to an appropriate “computation unit” within the context of an object-type solution to the problem, said computation unit being intended to compute images. The respective modules (for example the aforementioned computation unit) are then implemented on a microprocessor or on a chip).

At least one embodiment of the present invention is directed to a method for computing at least one image on the basis of raw data which have been acquired during a medical measurement process using an imaging method (for example using MR tomography) and which are buffered in a memory, wherein the method comprises the following method steps:

the raw data are provided;

parameters for computing the image are captured;

the image is computed from the provided raw data using the captured parameters, wherein the raw data provided by the memory are distributed over different evaluation consoles such that the image computation is performed with a load distribution and/or on the basis of the respective current resources.

The conceptualities used for describing at least one embodiment of the present invention are explained and/or clarified in more detail below.

The images are usually medical images which are evaluated during a medical process, such as a medical examination of a finding and/or a diagnosis. The images are computed from what are known as raw data.

The raw data are digital data which have been acquired by a computer-aided imaging modality. The images may thus relate to MR pictures, CT pictures (pictures from a computer tomograph), ultrasound images or PET images. Preferably, at least one embodiment of the present invention is designed for images from an MR unit. However, alternative embodiments provide for other imaging methods to be able to be used besides magnetic resonance tomography. Accordingly, it is obvious to a person skilled in the art that the term “MR unit” used in the claims can also be extended to other medical modalities. The raw data comprise a multiplicity of data records which relate to particular layer pictures on the respective scan, for example, and in this form and without further computation cannot be used for a medical diagnosis or examination. However, they are used as a basis for computing the images which can then be evaluated by the medical personnel. The raw data are acquired during a medical measurement process, that is to say by way of a CT or an MR examination, for example.

The memory is used for buffering the acquired raw data. It is preferably in the form of a buffer store or cache. The memory may, in principle, be based on different storage media. Thus, the memory may be a hard disk or a system of hard disks, for example. In the latter case, the memory may be in the form of what is known as a RAID system (RAID—Redundant Array of Independent Discs). Alternatively, the memory may be in the form of an (internal) main memory in a computer or in the form of a RAM disk or in the form of an external storage medium for storing digital data.

In one advantageous form of at least one embodiment of the present invention, provision is made for the memory to be in the form of what is known as a ring memory. This has the advantage that the respective most current data are present in the memory, since in the event of a memory overflow the respective oldest data are overwritten again. Alternatively, it is also possible to use other methods for managing memory systems which can operate on the basis of the LIFO principle, for example.

The memory may be in the form of an internal memory in computers or computation units which are provided anyway within a system for computing images. Alternatively, it is also possible for the memory to be relocated and designed as an external memory entity which is connected to the system according to the invention via an appropriate interface.

In one advantageous embodiment of the present invention, the memory can act as a server and can provide the raw data stored thereon on a client for computing and/or for further processing of the raw data. This extension holds the advantage that clients which are designed for computing medical images can actively retrieve the required raw data from the server (memory). Alternatively, they can be informed about “data newly stored in the memory” by way of a POP method. An alternative possibility is that the clients do not actively retrieve the required raw data from the server or the memory but rather that the server (memory) automatically provides the respective clients with the raw data in the manner of a PUSH method.

The memory is used primarily for buffering the raw data before the images are computed. The images computed from the raw data can either likewise be stored on the same memory or can be stored on other storage media. The memory comprises interfaces to the imaging appliance (e.g. the MR unit) and to a computation unit which is intended to compute the respective images. The computation unit may be an evaluation console, for example.

The term “providing” the raw data should be understood comprehensively and holds a plurality of alternatives in principle. Firstly, it is possible for the raw data also to be able to be provided directly by the imaging modality (e.g. by the MR scanner) in addition to the indirect provision of the raw data via the buffer store. Secondly, it is possible and preferable for the raw data always to be provided indirectly from the buffer acting as a buffer store.

Computation of the images requires parameters to be determined. The parameters are all the parameters which are relevant to the computation of the images and do not affect or alter the raw data. Examples which may be mentioned here are filter settings (e.g. normalized filter, B1 filter), meta data for the raw data, smoothing parameters, parameters for weighting diffusions, parameters for accentuating contours or parameters for correcting convolutions or for computing wavelet transformations and further parameters.

The method according to at least one embodiment of the invention is computer-implemented and based on the processing of digital data. Advantageously, the method according to at least one embodiment of the invention can also be applied to existing systems without the need to modify them to any great extent. In other words, existing systems can be developed by the memory according to the invention and/or by the relevant memory module which communicates or is incorporated in a network via the aforementioned interfaces.

In line with one advantageous development of at least one embodiment of the present invention, provision is made for the raw data to be provided by the memory. In this case, the images are thus no longer computed on the basis of raw data supplied directly or online by the MR unit, but rather are computed on the basis of the raw data buffered in the memory. This has the advantage that the process of data acquisition and the process of image data computation can be decoupled from one another and the image data computation can therefore be performed independently (or offline) of the capture.

In particular, it is possible for the images to be computed at any later time than the time at which the raw data are acquired. The buffering of the acquired raw data means that they can be used for different or repeat computations without the need to subject the patient to another MR examination. In other words, one and the same raw data record can be used to produce a set of different images, the images being computed on the basis of different parameters.

A further advantage of at least one embodiment can be seen in that the utilization of the respective MR unit can be improved by virtue of an MR measurement on a second patient being able to be performed directly after a measurement on a first patient even though the first measurement would need to be repeated on account of parameters which need to be changed. This repetition of the measurement is no longer necessary in accordance with the invention, since the computation can take place in a manner decoupled from the acquisition of the raw data and can also be performed using dynamically variable parameters.

As an alternative to the indirect provision of the raw data via the memory, it is naturally possible at any time to resort to the direct provision of the raw data as required and possibly for a portion of the data records. In that case, the raw data required for computing the images are provided no longer indirectly by the memory but rather directly by the MR unit. Depending on the medical application, it is also possible to combine the aforementioned types of provision. In other words, the indirect provision of raw data and the direct provision of raw data can be combined. In that case, a raw data stream is split into a direct stream of raw data (without buffering) and a buffered stream of raw data (which is routed via the memory according to at least one embodiment of the invention).

In line with at least one embodiment of the invention and advantageously, the computation of the images can be parameterized in variable fashion. The parameterized computation of the images is effected using the captured parameters. These parameters can be changed at any time in order to produce different images without the need for fresh capture of the underlying raw data. This produces the advantage that the parameters for the respective computation can be configured dynamically and can be adjusted flexibly in response to the respective medical application without the need for fresh acquisition of the raw data.

In one advantageous development of at least one embodiment of the invention, provision is made for the parameters to be captured in a parameter capture phase. The timing of this parameter capture phase is independent of that of an acquisition phase in which the raw data are acquired. Furthermore, the parameter capture phase is independent of an image computation phase in which the respective image is computed. The parameters merely need to be captured no later than when the process for image computation is intended to be started. Advantageously, the parameters can accordingly also be determined after the raw data have been captured. Alternatively, it is possible for the parameters to be actually determined in a preparation phase which is used for setting up the system and whose timing precedes that of the acquisition phase and the image computation phase.

The parameters can be read in from an external entity via an interface. Alternatively, it is also possible for the parameters to be input by a user using an appropriate user interface. It is therefore advantageously possible for the determination of the necessary parameters to be shaped very flexibly.

On account of the buffering of the raw data in the memory, it is possible for the image computation and/or reconstruction to be distributed over different evaluation consoles or to be relocated to a different console than the predetermined console. This distribution can be effected on the basis of a load, so that those or that evaluation console(s) which have/has the most resources at the respective time are/is selected. This feature allows further decoupling between image computation and raw data acquisition. This becomes possible by virtue of the respective raw data records being able to be taken from the memory and also loaded back into the memory. As soon as the raw data records are stored in the memory, they can be used for image computation. However, it is not necessary for the image computation to be started immediately at this time. Advantageously, it can be started at any later time, which also explains the term “retrospective reconstruction”.

The solution according to at least one embodiment of the invention produces the further advantage that the measurement time can be shortened because it is not necessary to repeatedly measure a patient in order to compute the image on the basis of the same raw data record and on the basis of different parameters. This allows patient throughput to be increased.

A further advantage of at least one embodiment is that it is also possible for different computations and different further processing steps to be performed on one and the same raw data record. For example, the further processing steps may be algorithms for testing the database or may be error correction modules. If a hardware module of the image computation unit fails on account of an error, for example, the same data record can be recomputed after the error has been corrected without the need to examine the patient again. The raw data record is therefore not lost.

If necessary, it is also possible for a raw data record to be read from the memory in order to allow this data record to be analyzed elsewhere (e.g. in the event of an error).

A further advantage of at least one embodiment of the present invention can be seen in that the measurement time and/or the image computation time can be shortened. Typical image computation times are in a range between several seconds and two minutes. In particular, it is possible for these times to be shortened by virtue of the image computation process being of modular design and only modules of the image computation process for which there were changes being recomputed. By way of example, the image computation process does not need to be repeated completely if only one parameter or a few parameters has/have been changed in the parameter record. The modules which are not affected by this change can be adopted unchanged from the previous computation process without being recomputed. It is merely necessary to recompute the modules which produce a modified result on account of the modified parameter(s).

In at least one embodiment, system is described for reconstructing images on the basis of raw data, wherein the system comprises the following:

at least one MR unit or another imaging modality for capturing the raw data;

at least one memory for buffering the raw data captured by the MR unit;

at least one computation unit having a parameter capture module, wherein the parameter capture module is intended to capture parameters for computing the images and wherein the computation unit is intended to compute the images from the raw data buffered in the memory using the parameters captured by the parameter capture module, wherein the raw data provided by the memory are distributed over different evaluation consoles such that the image computation by means of the computation units is performed with a load distribution, on the basis of the respective current resources.

It is possible for the computation unit, for its part, to comprise a plurality of modules which are distributed and/or implemented over different evaluation consoles. It is also possible for a central computation unit to be provided. Furthermore, the computation unit may also be in the form of a software application whose different functions can be distributed over various evaluation consoles, on the basis of the currently available resources. This achieves an optimized association—in terms of load distribution—between evaluation consoles and image reconstruction tasks.

Normally, the MR unit, the memory and the computation unit with the parameter capture module are connected to one another for data processing purposes via a network.

Preferably, the MR unit, the memory and the computation unit are in the form of separate modules. In this case, the system is of modular design and more flexible. Similarly, however, the memory may also be associated either with the MR unit or with the computation unit. In one case, the MR unit would be extended by means of the memory; in the other case, an image computation computer (evaluation console) would be extended by way of the memory.

Preferably, the computation unit is produced with the parameter capture module. However, it is alternatively likewise possible for the parameter capture module to be provided as a separate entity.

At least one embodiment is further directed to a memory module for buffering raw data which are used for reconstructing (computing) medical images, comprising:

at least one acquisition interface to an MR unit, via which the raw data captured on the MR unit are read in;

at least one memory for buffering the raw data;

at least one computation interface to at least one computation unit on which the images are computed in parameterizable fashion (that is to say on the basis of configurable parameters), wherein the raw data provided by the memory are distributed over different evaluation consoles such that the image computation is performed with a load distribution, on the basis of the respective current resources.

In one advantageous development of the memory module, the memory module is furthermore designed to store the computed images in addition to the raw data stored thereon.

In line with one advantageous development of the memory module, the memory module may be designed to additionally store the respectively used parameter sets which have been used for computing a respective image. Usually, the parameter data record used is assigned to the respective image and/or to the respective raw data record, so that the image computation becomes comprehensible and repeatable.

In line with another development of at least one embodiment of the invention, provision is made for the computed images to be stored in a database. For this, the image computation unit accesses a database writer which is designed to load the computed images into the database. Advantageously, it is possible to use conventional database writers known from the prior art for this.

### BRIEF DESCRIPTION OF THE DRAWINGS

The following detailed description of the figures discusses example embodiments—which are not intended to be understood as restrictive—with their features and further advantages with reference to the drawing, in which:

FIG. 1 shows an overview illustration of a system according to an embodiment of the invention based on a preferred embodiment of the invention, and

FIG. 2 shows a schematic flowchart based on an example embodiment of the invention.

The text below describes advantageous embodiments of the present invention with reference to the figures.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

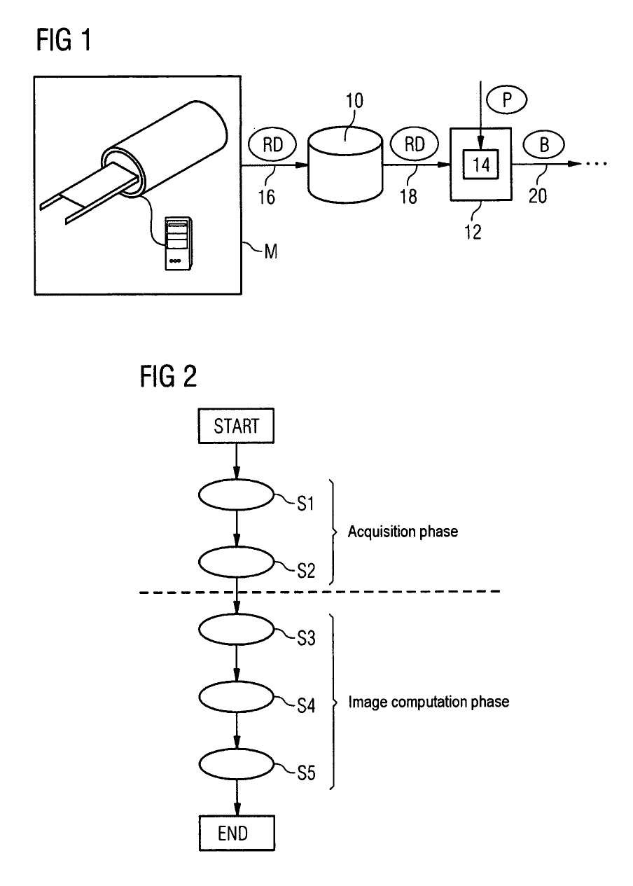

FIG. 1 schematically shows an overview of a design for a system according to the invention for computing images B on the basis of raw data RD, wherein the raw data RD are acquired and/or captured by an imaging modality M. This is shown on the left-hand side of FIG. 1. The raw data RD captured by the modality M, e.g. by an MR or CT unit M, cannot be used by a doctor, in principle, since they do not yet show an image. An image B must first be computed in a subsequent computation process (reconstruction).

In line with an embodiment of the invention, the raw data RD captured by the modality M are forwarded to a memory 10 which is used for buffering the raw data RD. As shown in FIG. 1, the memory 10 has at least two interfaces, an acquisition interface 16 to the modality M and a computation interface 18 to a computation unit 12. The computation unit 12 is shown on the right-hand side of FIG. 1. In one advantageous embodiment, the computation unit 12 comprises a parameter capture module 14. The parameter capture module 14 is used for capturing parameters P which are relevant to the computation of the images B and which do not influence the measurement data or raw data.

The computation module 12 has the computation interface 18 to the memory 10, an interface for capturing the parameters P using the parameter capture module 14 and an output interface 20 which is used to output the computed image B.

In addition to these interfaces, it is possible for the computation unit 12 to additionally comprise a further interface to the modality M (this interface is not shown in FIG. 1). This interface between modality M and computation unit 12 can then be used to supply the raw data RD directly to the computation by way of the computation unit 12. In the example embodiment, however, provision is made for, in principle, all raw data RD generated by the modality M always to be buffered in the memory 10. This has the advantage that the same raw data RD can be used multiple times for different computation processes.

In the embodiment shown in FIG. 1, the parameter capture module 14 is integrated in the computation unit 12. Alternatively, the parameter capture module 14 may also be in the form of an external entity which interchanges data with the computation unit 12. Raw data RD, once stored, can be used for a plurality of computations by the computation unit 12, which means that it is not necessary to capture the raw data RD again particularly for modified computation of the images B. The parameters P which are captured for the computation can be altered and/or adjusted at any time.

In one advantageous development of an embodiment of the invention, provision is made for additional information to be provided for the raw data RD. This additional information can comprise the following:

name of the file for the raw data RD,

protocol used (particularly for acquiring the raw data RD),

acquisition time,

status in reference to the raw data RD (for example whether the acquisition process is still running or is completely at an end), and

further meta information in reference to the acquisition of the raw data RD.

This additional information may likewise be stored in the memory 10. Furthermore, it is possible to provide a further piece of information. This further piece of information may concern identification of whether or not the respective set of raw data RD has already been used for computation. Usually, this is done using a flag in the respective data record. It is also possible to identify how often the respective data record of raw data RD has already been used for a computation by the computation unit 12.

The images B generated by the computation unit 12 can then be supplied to further processing steps. This is shown in FIG. 1 by the dots on the right-hand side. These may be post-processing steps, for example, or the display of the image B on a monitor.

FIG. 2 shows a possible flow based on an example embodiment of the present invention. When the method according to an embodiment of the invention is started, the raw data RD are captured in step S1. This is done by accessing the modality M. Usually, the modality M comprises an associated computer which is associated with an MR unit (as shown in FIG. 1).

Next, the raw data RD captured by the MR unit M are buffered in the memory 10. This is done in step S2.

In step S3, the raw data RD from the memory 10 are provided for the purpose of computing the image B.

In step S4, the computation unit 12 captures parameters P which are required for the respective computation of the image B. In FIG. 2, this step S4 is shown after step S3. This is only one option, however. Alternatively, it is likewise possible for the two steps S3, S4 to be transposed in time, so that first the parameters P are captured and then the raw data RD are provided. Alternatively, it is possible for the capture of the parameters P in step S4 to actually be performed at another earlier time, which may even be before or during the acquisition of the raw data RD, for example.

In step S5, the image B is computed from the raw data RD and using the captured parameters P. The parameters P need to be in place no later than the time at which the image B is computed in step S5.

When the image B has been computed, the method ends.

As FIG. 2 shows, the method is organized in two fundamental phases. Firstly, an acquisition phase is provided in which the raw data RD are captured by the MR unit M and in which (in step S2) the captured raw data RD are stored in the memory 10. This is followed by a second phase, what is known as an image computation phase. In this image computation phase, the image B is reconstructed from the raw data read from the memory 10. In the embodiment shown in FIG. 2, steps S1, S2 are associated with the acquisition phase, whereas steps S3, S4 and S5 are associated with the image computation phase. Alternatively, other associations may also be made in this case, however.

As indicated in FIG. 2 by the horizontal dotted line, the method according to the invention makes it possible to achieve further decoupling of the acquisition and the image computation. This affords the advantage that the image computations can be made even more flexible and independent of the raw data acquisition.

Clinical practice shows that it is not always possible to explicitly define in advance what parameters P need to be used in order to achieve optimum image quality. In the previous systems from the prior art, it was necessary for a medicotechnical assistant to try out a plurality of filters as parameters P, for example. To this end, the acquisition of the raw data RD always needed to be repeated, since said raw data could not previously be buffered. If the images B were thus not optimum with the preset filter values, the patient had to be subjected to another measurement. This is no longer necessary on the basis of the method according to the invention, since one and the same set of raw data RD can be used for differently parameterized computations.

It is obvious to a person skilled in the art that the system according to an embodiment of the invention may additionally comprise further modules for the use and management of the memory 10. By way of example, the system may furthermore be designed to have a reader (read module) for read access to the memory 10 and to have a writer (write module) for write access to the memory 10. Similarly, further modules may be provided for the operation of the memory 10. In addition, other modules may be provided for the operation of the memory 10. Furthermore, it is possible to connect a further database to the memory 10, for example in order to be able to explicitly access specific data records in the database.

In one advantageous development of an embodiment of the invention, provision is made for a rule base to be accessed in which it is possible to configure rules which determine which set of parameters P is suitable for a particular kind of raw data RD and/or for a particular kind of computation. This feature allows the parameters P to be preconfigured. However, it is at all times possible to modify these preconfigured parameters P automatically or manually.

Finally, it should be pointed out that the description of the invention and the example embodiments should, in principle, be understood to be non-restrictive in respect of a particular physical implementation of the invention. It is particularly clear to a person skilled in the art that the invention can be implemented partly or fully in software and/or hardware and/or with a distribution over a plurality of physical products—in this particularly including computer program products or over the modality M or the computation unit 12.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A computer-implemented method for computing medical images on the basis of raw data, wherein the raw data are data captured via an MR unit and are buffered in a memory, the method comprising:
providing the raw data;
capturing parameters for computing the medical images;
computing the medical images, using the captured parameters, on the basis of the provided raw data, the raw data provided by the memory being distributed over different evaluation consoles, so that the medical images are computed with a load distribution, on the basis of respective currently available resources.

2. The method as claimed in patent claim 1, wherein the raw data are provided by the memory.

3. The method as claimed in patent claim 1, wherein the parameters are read in from an external entity via an interface or are input using a user interface.

4. The method as claimed in claim 1, wherein the parameters are dynamically variable and wherein different parameter sets are applicable to the same raw data in order to perform different image computations.

5. The method as claimed in claim 1, wherein at least one of different computations and different algorithms for computation are applicable to one and the same set of raw data.

6. The method as claimed in claim 1, wherein at least one of
only extracts from the provided raw data are used for computation, and
the computation is based on different sets of raw data.

7. A computer-aided system for computing medical images on the basis of raw data, comprising:
at least one magnetic resonance unit for capturing the raw data;
at least one memory for buffering the raw data, adapted to use an acquisition interface to interchange data with the magnetic resonance unit and to use a computation interface to interchange data with a computation unit; and
at least one computation unit including a parameter capture module, wherein the parameter capture module is adapted to capture parameters for computing the medical images and wherein the computation unit is adapted to compute the medical images from the raw data buffered in the memory using the parameters captured by the parameter capture module, wherein the raw data provided by the memory are adapted to be distributed over different evaluation consoles so that the medical images are computed with a load distribution, on the basis of the respective currently available resources.

8. A computer program product, loadable into a memory in a computer, comprising program code segments to perform the method as claimed in claim 1 when the computer program product is executed in the computer.

9. A memory module for buffering raw data, useable for computing medical images, comprising:
at least one acquisition interface to a magnetic resonance unit on which the raw data are captured;
at least one memory for buffering the captured raw data; and
at least one computation interface to at least one computation unit, wherein the medical images are adapted to be respectively computed on the computation unit from the raw data buffered in the memory using configurable parameter sets and wherein the raw data provided by the memory are adapted to be distributed over different evaluation consoles, so that the medical images are computed with a load distribution, on the basis of the respective currently available resources.

10. The method as claimed in patent claim 2, wherein the parameters are read in from an external entity via an interface or are input using a user interface.

11. The method as claimed in claim 2, wherein the parameters are dynamically variable and wherein different parameter sets are applicable to the same raw data in order to perform different image computations.

12. The method as claimed in claim 2, wherein at least one of different computations and different algorithms for computation are applicable to one and the same set of raw data.

13. The method as claimed in claim 4, wherein at least one of different computations and different algorithms for computation are applicable to one and the same set of raw data.

14. The method as claimed in claim 2, wherein at least one of only extracts from the provided raw data are used for computation, and
the computation is based on different sets of raw data.

15. A computer readable medium including program segments for, when executed on a computer device, causing the computer device to implement the method of claim 1.
